(19) United States
(12) Patent Application Publication
(10) Pub. No.: US 2026/0300477 A1
(43) Pub. Date: Oct. 1, 2026

(54) GENERATIVE ARTIFICIAL INTELLIGENCE-BASED FRAMEWORK FOR TRAINING A MACHINE LEARNING MODEL

(71) Applicant: PAYPAL, INC., San Jose, CA (US)

(72) Inventors: Tian Peng, Shanghai (CN); Wei Sun, Singapore (SG); Weilin Fu, Shanghai (CN); Chao Wang, Shanghai (CN); Yanlin Wang, Shanghai (CN); Jiazheng Zhang, Singapore (SG)

(21) Appl. No.: 19/093,043

(22) Filed: Mar. 27, 2025

(51) Int. Cl. G06F 21/55

(52) U.S. Cl. CPC G06F 21/554; G06F 2221/033

(57) ABSTRACT

Methods and systems are presented for providing an artificial intelligence (AI)-based framework for generating training data and training a machine learning model configured to detect tampering of documents. The AI-based framework includes an AI model that is trained to modify a sample document by replacing one or more contents from the sample document with one or more synthetic contents. Based on a prompt that includes an “EMPTY” token, the AI model removes the one or more contents from the sample document and fill any missing background graphics with synthetic graphics. The AI model then inserts the one or more synthetic contents into the areas where the one or more contents were removed. The modified document is used to generate training data to train the machine learning model.

### BACKGROUND

The present specification generally relates to artificial intelligence, and more specifically, to a generative artificial intelligence-based framework that generates training data for training machine learning models according to various embodiments of the disclosure.

### RELATED ART

Machine learning models have been widely used to perform various tasks for different reasons. For example, machine learning models may be used in classifying data (e.g., determining whether a document is authentic, determining whether a document has been tampered with, etc.). To construct a machine learning model, a set of input features that are related to performing a task associated with the machine learning model are identified. Training data that includes attribute values corresponding to the set of input features and labels corresponding to pre-determined prediction outcomes may be provided to train the machine learning model. Based on the training data and labels, the machine learning model may learn patterns associated with the training data, and provide predictions based on the learned patterns. For example, new data (e.g., transaction data associated with a new transaction) that corresponds to the set of input features may be provided to the machine learning model. The machine learning model may perform a prediction for the new data based on the learned patterns from the training data (e.g., whether the new transaction is likely to be fraudulent).

While machine learning models are effective in learning patterns and making predictions, the performance of the machine learning models is typically dependent on the quality of the training data used to train the machine learning models. When a sufficient amount of high-quality training data (e.g., a volume of training data exceeding a threshold, a diversity of training data exceeding a threshold, training data that accurately represents real-world data, etc.) is available to train a machine learning model, the machine learning model may be trained to perform a task with a high accuracy (e.g., having an accuracy level that exceeds a desired threshold). On the other hand, when a sufficient amount of high-quality training data is not available to train the machine learning model, the machine learning model may perform the task with a low accuracy (e.g., having an accuracy level below the desired threshold).

High-quality training data includes data that adequately represents (e.g., mimics, etc.) real-world content to be classified by the machine learning model. Such high-quality training data is typically obtained based on historic data that has been previously classified by the machine learning model or by other means (e.g., human labeling, etc.). However, for certain types of tasks, high-quality training data can be difficult to obtain. For example, for a task that is related to determining whether a document is authentic (e.g., whether an identity document has been tampered with, etc.), high-quality training data may include a large number of authentic identity documents and a large number of fraudulent identity documents. However, fraudulent identity documents (e.g., identity documents that have been tampered with, etc.) may not be widely available, such that the number of training data that is labeled as fraudulent documents may not be sufficiently large, and/or not be representative of most or all types of fraudulent documents, such that the training data is not comprehensive enough to train the machine learning model with sufficient accuracy. Furthermore, the real-world documents (either authentic or fraudulent documents) may include sensitive personal information that should not be used as training data for training machine learning models. As such, there is a need for providing a framework for generating high-quality training data for machine learning models.

### BRIEF DESCRIPTION OF THE FIGURES

FIG. 1 is a block diagram illustrating an electronic transaction system according to an embodiment of the present disclosure;

FIG. 2 is a block diagram illustrating an artificial intelligence (AI) module according to an embodiment of the present disclosure;

FIG. 3 illustrates an example data flow for generating training data for training a machine learning model according to an embodiment of the present disclosure;

FIG. 4 illustrates an example data flow for using an AI model to modify text contents in a document according to an embodiment of the present disclosure;

FIG. 5 illustrates an example data flow for using an AI model to modify image contents in a document according to an embodiment of the present disclosure;

FIG. 6 illustrates an example training data set according to an embodiment of the present disclosure;

FIG. 7 is a flowchart showing a process of training an AI model to generate fraudulent documents according to an embodiment of the present disclosure;

FIG. 8 is a flowchart showing a process of using a AI model to generate training data for training a machine learning model according to an embodiment of the present disclosure;

FIG. 9 illustrates an example neural network that can be used to implement a machine learning model according to an embodiment of the present disclosure; and

FIG. 10 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for providing an artificial intelligence (AI)-based framework for generating training data and training machine learning models configured to detect authenticity of documents. Online service providers, such as online financial institutions, government agencies, online merchants that sell restricted items, etc., often require users to provide legal documents (e.g., government-issued identification documents, such as passports, drivers'licenses, identification cards, etc.) to verify an attribute (e.g., an identity, an age, etc.) of the users. These legal documents typically include different types of content, such as a name, an identification number, a birthdate, a portrait image of a person, etc. By extracting contents from the legal documents, the online service providers may verify attributes associated with the users (e.g., verifying an identity of the user by comparing a live image of the user against the image of a person on the document, verifying an age of the user, etc.).

However, certain malicious users may attempt to gain unauthorized access to online resources through the online service providers by providing a fraudulent document (e.g., a document that has been tampered with based on modifying one or more of the contents included in the document, etc.). In order to prevent such an unauthorized access of the online resources, online service providers have implemented computer features for detecting whether a document (e.g., an image of the document, etc.) submitted by a user is a fraudulent document. Machine learning models have been commonly used to perform such a detection task due to its capability of classification prediction based on learning from training data.

As discussed herein, the accuracy performance of a machine learning model typically depends on the quality of training data available to train the machine learning model. However, for tasks such as detecting authenticity of documents, there are several challenges in obtaining high quality training data. First, most of the documents submitted to be processed (e.g., requiring detection of authenticity, etc.) are authentic documents. In other words, the proportion of fraudulent documents relative to authentic documents is small (e.g., smaller than a threshold, such as 1/1000, 1/10,000, etc.), and the availability of such detected fraudulent documents is limited. Second, since the documents being processed (e.g., authenticated, etc.) are typically identity documents, such as passports, drivers'licenses, identification cards, etc., they contain sensitive information such as personal identifiable information (PII). Training the machine learning model with real-world samples might not be permitted according to different rules and regulations. Third, techniques for tampering a document (e.g., changing one or more of the contents in a document, etc.) have become more sophisticated and are constantly evolving, especially with the use of generative AI capabilities. Relying on existing documents that have been detected to be fraudulent might not be sufficiently adequate to train the machine learning model to accurately detect fraudulent documents generated using the evolving techniques.

As such, the AI-based framework provides techniques for configuring, training, and utilizing one or more generative AI models to generate training data that mimics real-world fraudulent documents. The training data may then be used to train a machine learning model configured to detect fraudulent documents. One of the advantages of using the AI-based framework to generate training data for the machine learning model is that a large quantity of fraudulent documents (also referred as “modified documents” or “tampered documents”) can be generated based on a small number of sample documents. For example, a computer system may obtain a sample document corresponding to a particular document type (e.g., a United States passport, a California driver's license, a U.K. passport, etc.). The sample document may be obtained from an online server (e.g., a government's website, etc.), a user device, or other sources, or may be generated by the generative AI model. The computer system may use the generative AI model to generate a large number of tampered documents based on the sample document by iteratively modifying one or more contents within the sample document using different tampering techniques.

The different modification techniques may correspond to known techniques used by malicious users in the past and/or advanced prompting techniques using the generative AI model that may predict tampered documents not yet identified or available as training data. For example, the computer system may use the generative AI model to modify a particular content (e.g., a birthdate, a name, an image of a person's face, etc.) by replacing the original content with different replacement contents using different techniques. The computer system may continue to use the generative AI model to modify different contents on the sample documents (and/or modifying the same content using different techniques) to generate a large number of modified (e.g., tampered) documents. The computer system may then label the modified documents by adding annotations to the content that has been replaced or altered. The annotations may indicate the type of content and/or the location of the content being modified, and the technique used to modify the content. The computer system may generate training data for the machine learning model using the modified documents along with the annotations. Each training data set may include a modified document and the corresponding annotations. Since the modified documents are generated using different techniques commonly used by malicious users to modify the documents, the modified documents closely resemble real-world fraudulent documents. As such, the modified documents generated in this manner can be used to generate high-quality training data for training the machine learning model, which can substantially improve the detection accuracy of the machine learning model.

To generate a modified document under the framework, the computer system may first obtain an image of a sample document of a particular document type. The sample document may be obtained from a government website or any other sources (e.g., generated by the generative AI model, etc.), and may not include sensitive information associated with a person, where the sensitive information may be replaced with non-sensitive information, such as a random birthdate or social security number. The computer system may analyze the image of the sample document to identify the locations and content types of different modifiable contents included in the sample document. For example, the computer system may determine that the sample document includes an image of a person's face on the left of the document, an identification number in the middle, a name below the identification number, an address below the name, a birthdate below the address, and an expiration date below the birthdate. All of the identified contents correspond to content types that are potentially modifiable by malicious users to generate fraudulent documents.

In some embodiments, the computer system generates a mask based on the locations of the different contents appearing on the document. The mask may specify (e.g., highlight) the areas within the document that include the different contents. Using the mask, the computer system may instruct a generative AI model to perform different operations on the content of the sample document.

For example, the computer system may instruct the generative AI model to modify text contents (e.g., a name, a birthdate, an expiration date, etc.) of the sample document based on the mask. In an effort to combat tampering of documents, many government-issued documents include a graphical background (e.g., background images, patterns with colored lines, etc.). Contents are typically superimposed on top of the graphical background in the document, such that changes to the text contents may create artifacts in the background graphics (e.g., missing portions of the graphics, etc.). In order to reduce the background artifacts when replacing contents in the sample document, the computer system may instruct the generative AI model (e.g., through one or more prompts, etc.) to copy partial contents from other areas of the sample document, and replace an original content of the sample document using a combination of partial contents extracted (e.g., copied) from other areas. For example, various numerals from the expiration date or the document number of the sample document may be copied. The numerals may then be combined to generate a replacement birthdate to replace the original birthdate on the sample document. Since the replacement contents are generated using various partial contents from the sample document, the background graphics are also copied over to the replaced area of the sample document, which reduces the appearance of missing background graphics. The computer system may instruct the generative AI model to modify the same or different contents using different combinations of partial contents copied from other areas of the sample document to generate multiple modified documents, which can be used to generate training data for training the machine learning model.

However, since the replacement contents are extracted from different locations than the original contents, the graphical background of the replacement contents may be inconsistent (e.g., disconnected lines in the graphical background, disconnected images in the graphical background, etc.). As such, the computer system of some embodiments may also instruct the generative AI model to use a more advanced technique to modify the text contents of the sample document. Using the advanced technique, the computer system may first instruct the generative AI model (e.g., through one or more prompts, etc.) remove the original content(s) on the sample document, before inserting the replacement content(s). In some embodiments, the computer system may use a special token—an “EMPTY” token—in the prompt for instructing the generative AI model to modify the content(s). For example, the computer system may assign the “EMPTY” token(s) to one or more areas on the sample document. The generative AI model may be trained to recognize the “EMPTY” tokens in the prompt, and to remove the original content(s) from the specified one or more areas on the sample document based on the “EMPTY” token assignments.

There are multiple advantages in using the “EMPTY” token for instructing the generative AI model to modify the content(s). First, when the generative AI model is instructed to replace the original content with a replacement content, if the replacement content is shorter than the original content, the generative AI model may exhibit an effect known as “hallucination,” where the generative AI model may generate additional content to fill the space where the original content was removed, such that the actual content that was added to the location is different from the replacement content that the generative AI model was instructed to use. For example, when the original content is “Devon Michael Sawyer” and the replacement content is “Aria,” the generative AI model may replace the original content with “AAAAArIIIII sawria” in order to match the content length. As such, the computer system may train the generative AI model to associate the “EMPTY” token with an instruction for removing the original content(s) from the sample document. The generative AI model may first remove all of the original content(s) from the specified area(s) of the sample document before inserting the replacement content in the specified area(s) based on the “EMPTY” tokens assigned to the specified area(s). By first removing the original content(s) from the specified area(s), the computer system eliminates the potential hallucination effect of the generative AI model.

Second, since the original content(s) were superimposed on the pre-existing background graphics of the sample document, simply removing the original content(s) may create empty spots (e.g., missing graphics, etc.) in the background. Even when replacement content(s) is inserted back into the same areas of the sample document, due to the different lengths and different characters between the replacement content(s) and the original content(s), there may still be empty spots (e.g., missing graphics, etc.) in the background of the areas where the content(s) is replaced. In some embodiments, the computer system may train the generative AI model to fill the missing graphics with replacement graphics in the area(s) when the original content(s) is removed based on the “EMPTY” token. Since different sample documents of the same document type may include different contents (e.g., different numerals, different characters, etc.), the generative AI model may determine the entire background graphics by reviewing and analyzing the different sample documents in a collective manner. As such, by training the generative AI model using multiple sample documents of the same document type and assigning “EMPTY” tokens to different areas, the generative AI model may learn how to accurately fill the missing background graphics.

The computer system may train the generative AI model by providing different input data sets. Each input data set may include an image of a sample document, a mask, and a prompt that instructs the generative AI model to remove the content(s) highlighted in the mask using one or more “EMPTY” tokens. In each training iteration, the generative AI model is instructed, based on the “EMPTY” tokens, to remove the original content(s) highlighted in the mask from the sample document and fill the pixels corresponding to the removed content(s) with generated background graphics. The document, after the content(s) is removed, is compared with other sample documents of the same type to determine any deviations in the background graphics. The feedback is then provided to the generative AI model to adjust the model parameters through a backward propagation step (e.g., training using a loss function associated with minimizing the differences with other sample documents). Through multiple training iterations, the generative AI model may learn to accurately fill the missing background graphics after content(s) is removed from a sample document.

After the generative AI model is trained, the computer system may instruct the generative AI model to remove the original content(s) and accurately fill the missing background graphics after the original content(s) is removed. The computer system may then instruct the generative AI model (e.g., through one or more prompts) to add replacement contents to the locations where the original text contents were removed. In some embodiments, when the computer system analyzes the text contents of the sample document, the computer system also determines a font type and a font size used for each of the different contents appearing on the sample document. As such, the computer system may also instruct the generative AI model to generate the replacement content using the same font type and the same font size as the original text contents. Since the replacement text contents are inserted onto the sample document after the original text contents were removed and the graphical background around the removed contents were filled, the graphical background around the replacement contents will appear consistent with the rest of the graphical background (e.g., flow with the other portions of the graphical background, etc.). In some embodiments, the computer system may instruct the generative AI model to add the replacement contents to the locations with an objective of minimizing a difference between the original sample document and the modified document.

In addition to modifying text contents, the computer system may also use the generative AI model to modify image contents of the sample document. As discussed, most of the documents include one or more images of a person (e.g., a head and shoulder photo of a person, etc.). As such, the computer system may use the generative AI model to replace either the face on the image of the person or the entire image of the person. To replace the face on the image of the person, the computer system may instruct the generative AI model to generate a new face based on a set of characteristics, remove the facial features of the original face, and insert the newly generated face onto the image. In some embodiments, the computer system may further instruct the generative AI model to align the newly generated face in the original image such that the newly generated facial features appear to be natural in the image.

To replace the entire image, the computer system may first generate an image mask for the image. The image mask outlines the image of the person (e.g., following the contour of the person's head, face, and shoulder, etc.). The computer system may then instruct the generative AI model to remove the image of the person based on the image mask. Similar to the text content, after removing the original image of the person, the computer system may instruct the generative AI model to reconstruct part of graphical background (e.g., a synthetic background) around the location where the original image of the person was removed. After reconstructing the graphical background on the sample document, the computer system may instruct the generative AI model to generate a new image of a person having different facial features, and insert the new image of the person in the location of the sample document where the original image was removed.

The computer system may continue to modify the sample document in different manners, for example, replacing different types of content with different replacement contents and/or using different tampering techniques. By using the generative AI model, the computer system may create a large number of modified documents that have been modified using different techniques based on a small number of sample documents. The computer system may then generate training data based on the modified documents. For example, for each of the modified documents, the computer system may generate annotations that describe one or more locations on the modified documents where contents have been modified (e.g., tampered with). The computer system may then generate a training data set based on the modified document and the corresponding annotations. The computer system then trains (or re-trains) the machine learning model using the training data. Since the training data includes a large number of modified documents that have been modified using the techniques disclosed herein to mimic real-world fraudulent documents, training the machine learning model using the training data would substantially improve the accuracy performance of the machine learning model in classifying documents.

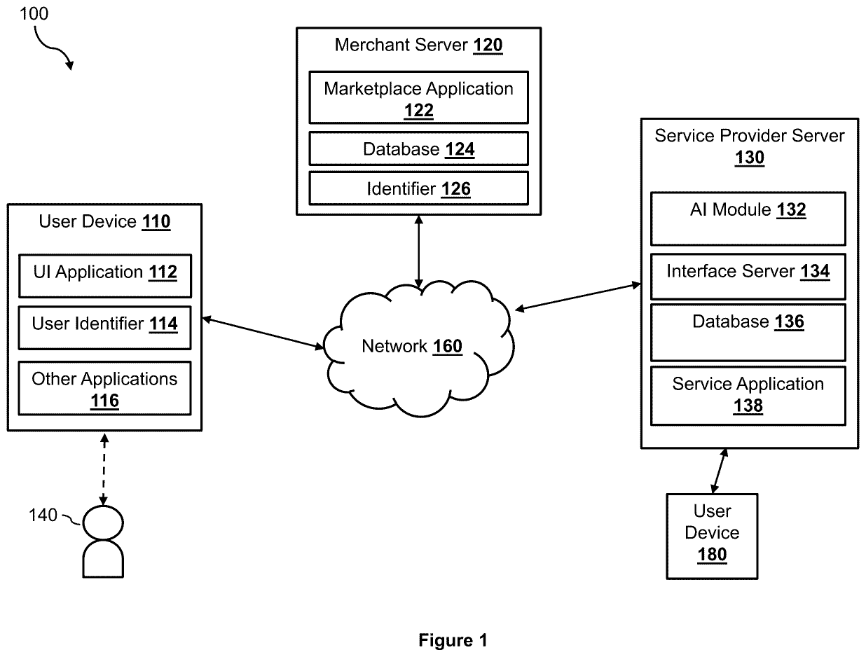

FIG. 1 illustrates an electronic transaction system 100, within which the AI-based framework system may be implemented according to one embodiment of the disclosure. The electronic transaction system 100 includes a service provider server 130, a merchant server 120, and user devices 110 and 180 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant server 120 and/or the service provider server 130 over the network 160. For example, the user 140 may use the user device 110 to conduct an online purchase transaction with the merchant server 120 via websites hosted by, or mobile applications associated with, the merchant server 120. The user 140 may also log in to a user account to access account services or conduct electronic transactions (e.g., data access, account transfers or payments, etc.) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160. Thus, the user 140 may use the user interface application 112 to initiate electronic transactions with the merchant server 120 and/or the service provider server 130.

The user device 110, in various embodiments, may include other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 and/or the chat client 170 for improved efficiency and convenience.

The user device 110, in one embodiment, may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile).

In various implementations, the user 140 is able to input data and information into an input component (e.g., a keyboard) of the user device 110. For example, the user 140 may use the input component to interact with the UI application 112 (e.g., to conduct a transaction with the merchant server 120 and/or the service provider server 130, etc.). In another example, when the merchant server 120 and/or the service provider server 130, via the UI application 112, requests to verify an identity of the user 140, the user 140 may use a camera of the user device 110 to capture an image of a government-issued document of the user (e.g., a passport, driver's license, etc.), and transmit the image of the document to the merchant server 120 and/or the service provider server 130 via the network 160.

The user device 180 may include substantially the same hardware and/or software components as the user device 110, which may be used by a user to interact with the merchant server 120 and/or the service provider server 130.

The merchant server 120, in various embodiments, may be maintained by a business entity (or in some cases, by a partner of a business entity that processes transactions on behalf of the business entity). Examples of business entities include merchants, resource information providers, utility providers, online retailers, real estate management providers, social networking platforms, a cryptocurrency brokerage platform, etc., which offer various items for purchase and process payments for the purchases. The merchant server 120 may include a merchant database 124 for identifying available items or services, which may be made available to the user devices 110 and 180 for viewing and purchase by the respective users.

The merchant server 120, in one embodiment, may include a marketplace application 122, which may be configured to provide information over the network 160 to the user interface application 112 of the user device 110. In one embodiment, the marketplace application 122 may include a web server that hosts a merchant website for the merchant. For example, the user 140 of the user device 110 (or the user of the user device 180) may interact with the marketplace application 122 through the user interface application 112 over the network 160 to search and view various items or services available for purchase in the merchant database 124. The merchant server 120, in one embodiment, may include at least one merchant identifier 126, which may be included as part of the one or more items or services made available for purchase so that, e.g., particular items and/or transactions are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 1, it has been contemplated that multiple merchant servers, each associated with a different merchant, may be connected to the user device 110 and the service provider server 130 via the network 160.

The service provider server 130, in one embodiment, may be maintained by a transaction processing entity or an online service provider, which may provide processing of electronic transactions between users (e.g., the user 140 and users of other user devices, etc.) and/or between users and one or more merchants. As such, the service provider server 130 may include a service application 138, which may be adapted to interact with the user device 110 and/or the merchant server 120 over the network 160 to facilitate the electronic transactions (e.g., electronic payment transactions, data access transactions, etc.) among users and merchants processed by the service provider server 130. In one example, the service provider server 130 may be provided by PayPal®, Inc., of San Jose, California, USA, and/or one or more service entities or a respective intermediary that may provide multiple point of sale devices at various locations to facilitate transaction routings between merchants and, for example, service entities.

In some embodiments, the service application 138 may include a payment processing application (not shown) for processing purchases and/or payments for electronic transactions between a user and a merchant or between any two entities (e.g., between two users, between two merchants, etc.). In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user devices 110 and 180 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various services provided by the service provider server 130. The interface server 134 may also include other electronic pages associated with the different services (e.g., electronic transaction services, etc.) offered by the service provider server 130. As a result, a user (e.g., the user 140, the user of the user device 180, or a merchant associated with the merchant server 120, etc.) may access a user account associated with the user and access various services offered by the service provider server 130, by generating HTTP requests directed at the service provider server 130.

The service provider server 130, in one embodiment, may be configured to maintain one or more user accounts and merchant accounts in an accounts database 136, each of which may be associated with a profile and may include account information associated with one or more individual users (e.g., the user 140 associated with user device 110, the user associated with the user device 180, etc.) and merchants. For example, account information may include private financial information of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions. It is noted that the accounts database 136 (and/or any other database used by the system disclosed herein may be implemented within the service provider server 130 or external to the service provider server 130 (e.g., implemented in a cloud, etc.).

In one implementation, a user may have identity attributes stored with the service provider server 130, such as in the database 136, and the user may have credentials to authenticate or verify identity with the service provider server 130. User attributes may include personal information, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server 130 also includes an artificial intelligence (AI) module 132 that implements the AI-based framework as discussed herein. As discussed herein, some of the services provided by the service provider server 130 and/or the merchant server 120 may require a verification of one or more attributes of the user. For example, when the user 140 requests to register for an account with the service provider server 130, the service provider server 130 may require the user 140 to verify one or more attributes of the user 140 (e.g., verifying an identity of the user, verifying an age of the user, etc.) before activating the account for the user 140. In another example, when the user 10 requests to purchase a particular product that is age-restricted from the merchant server 120 via the service provider server 130, the service provider server 130 may require the user 140 to verify an age of the user 140. The service provider server 130 may request the user to submit an image of a government-issued identity document (e.g., a passport, a driver's license, etc.). Upon receiving the document, the service provider server 130 may extract content from the document, such as a photo of the user, a name, a birthdate, etc. The service provider server 130 may also use obtain a live-image of the user 140 via the user device 110, and compare the live-image of the user 140 against the photo on the document. The service provider server 130 may then extract other content from the document and verify one or more attributes (e.g., a name, a birthdate, etc.) of the user 140. The service provider server 130 may determine whether to provide the user 140 access to the service (e.g., access to an account, access to data, etc.) based on the attributes extracted from the document.

It is known that malicious users may attempt to gain unauthorized access to the services provided by the service provider server 130 and/or the merchant server 120 by submitting a fraudulent document (e.g., forged documents, documents that have been tampered with, etc.). A fraudulent document is either a document that is not what the document claims to be (e.g., not an actual passport issued by a government, etc.) or having at least some of the contents modified (e.g., tampered with). As such, before verifying the attributes of the user based on the content of the document, the service provider server 130 may use the AI module 132 to determine an authenticity of the document (e.g., whether the document is authentic or fraudulent).

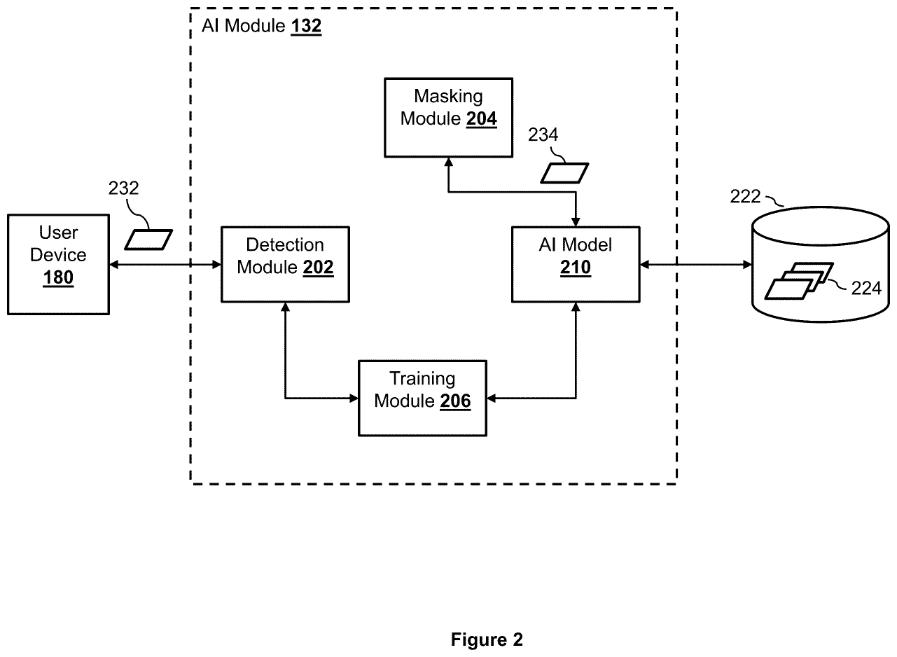

FIG. 2 illustrates a block diagram of the AI module 132 according to an embodiment of the disclosure. The AI module 132 includes a detection module 202, a masking module 204, an AI model 210, and a training module 206. In some embodiments, the detection module 202 may be implemented as (or include) a machine learning model (e.g., an artificial neural network, etc.) that is configured to accept an image of a document as an input (e.g., provided by the user 140 via the user device 110), and produce an output indicating whether the document is a fraudulent document. In order to improve the classification accuracy of the detection module 202, the AI module 132 may use the AI model 210 to generate training data, and use the training module 206 to train the detection module 202.

In some embodiments, the AI model 210 is a generative AI model (e.g., a large language model, etc.) that can generate content (e.g., text content, image content, etc.) based on instructions included in a prompt. As such, the AI module 132 may use the AI model 210 to generate fraudulent documents, that mimic real-life government-issued documents that have been tampered with by malicious users, as training data for training the detection module 202.

To generate the training data for the detection module 202, the AI module 132 may first obtain a sample document 232 that corresponds to a particular document type (e.g., a U.S. passport, etc.). For example, the sample document 232 may be obtained from a government website, a user device 180 of a user associated with the service provider server 130, or an external server. The sample document may correspond to an actual document issued by a government to an individual person, or a sample provided by the government using arbitrary content (e.g., an arbitrary name, an arbitrary birthdate, etc.).

The AI module 132 may use the masking module 204 to analyze the sample document 232 and generate a mask 234 for the sample document 232. The mask 234 may indicate the locations of different contents that appear on the sample document 232. For example, the mask 234 may include borders surrounding each of the different contents (e.g., an image of a person, an identification number, a name, a birthdate, a gender, an expiration date, a height, a color of the hair, etc.). The mask 234 may be used by the AI model 210 to detect the locations of the different contents, such that the AI model 210 can analyze and modify the contents on the sample document 232. After generating the mask 234, the AI module 132 may instruct the AI model 210 to generate various modified documents 224 by modifying different contents in the sample document 232 using different tampering techniques based on the sample document 232 and the mask 234. The AI module 132 may store the modified documents 224 in a data storage 222.

In some embodiments, the AI module 132 may also instruct the AI model 210 to annotate the modifications made to the sample document 232 when generating each modified document. For example, the AI model 210 may generate annotations that indicate the type of content (and/or location of the content) that has been modified from the sample document 232 for each of the modified documents 224. The annotations may also indicate how the content was modified from the sample document 232 for each of the modified documents 224.

In some embodiments, the AI module 132 may continue to generate different modified documents based on different sample documents (that may correspond to different document types). For example, the AI module 132 may obtain another sample document corresponding to a different document type (e.g., a passport issued by another country, an identification card, etc.). Similar to the sample document 232, the AI module 132 may also use the masking module 204 to generate a mask for this new sample document, and then use the AI model 210 to generate various modified documents based on the mask and the sample document. The AI model 210 may also generate annotations indicating the type of contents (and/or the locations of the contents) that have been modified and/or the way they were modified. The AI module 132 may continue to generate additional modified documents for different document types, and store the modified documents in the data storage 222.

The AI module 132 may then use the training module 206 to generate training data for the detection module 202 using the modified documents 224 stored in the data storage 222. For example, each training data set in the training data may include a modified document and the corresponding annotations. The training module 206 may then use the training data to train the detection module 202 to improve the prediction accuracy of the detection module 202.

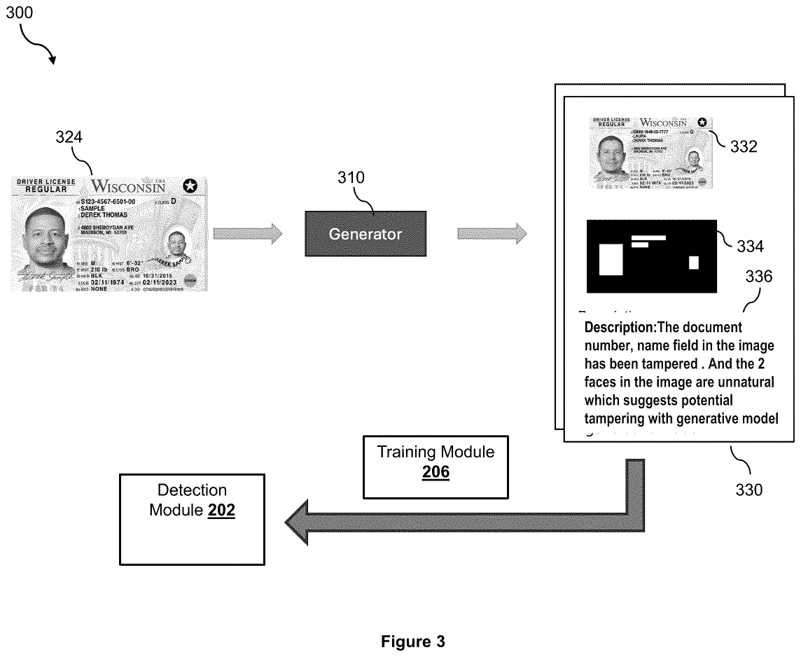

FIG. 3 illustrates an example data flow 300 for generating a training data set for training the detection module 202 according to an embodiment of the disclosure. As shown in FIG. 3, a sample document 324 is used to generate a training data set 330. In this example, the sample document 324 is a Wisconsin driver's license. The sample document 324 is provided to a generator 310, which may correspond to various components of the AI module 132, such as the masking module 204 and the AI model 210. The generator 310 may generate a mask 334 based on analyzing the sample document 324. The mask 334 may indicate various types of contents (and/or locations of the contents) that are modifiable by the generator 310 for the particular type of document. For example, the mask 334 may highlight various areas (e.g., in various shapes such as a rectangle shape, etc.) specific to a Wisconsin driver's license that include the contents that the generator 310 is allowed to modify for generating modified documents. In this example, the mask 334 highlights the images of the person, the driver's license number, and the name. The generator then generates a modified document 332 based on the sample document 324 and the mask 334. Specifically, the generator 310 generates a synthetic content (in this example, an artificially generated face), and replace the original content (e.g., the original image of the person) with the synthetic content. The generator 310 also replaces the name and the driver's license number on the sample document 324 with different synthetic contents (e.g., an arbitrarily generated number and an arbitrarily generated name).

The generator 310 may also generate an annotation 336 for the modified document 332. The annotation 336 describes the different contents within the modified document 332 that have been modified from the original sample document 324. In this example, the annotation 336 includes the description “the document number, name field in the image has been tampered with, and the two faces in the image are unnatural, which suggests potential tampering of the two faces using a generative model.” The training module 206 may then use the training data set 330, along with other training data sets generated using the same techniques as discussed herein, to train the detection module 202.

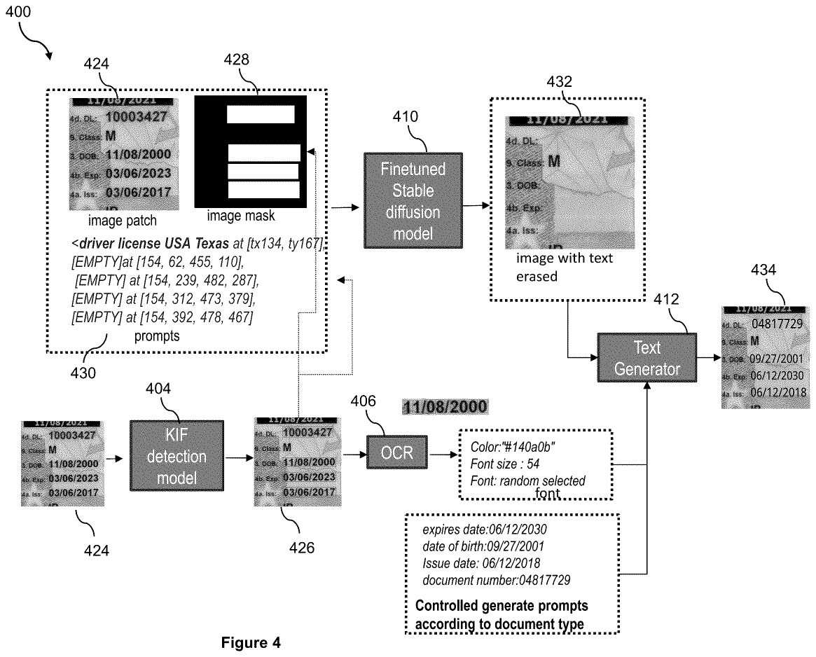

FIG. 4 illustrates an example data flow 400 for modifying text contents within a document according to an embodiment of the disclosure. In this example, an image patch 424 represents a portion of a sample document that is provided to the AI module 132. The AI module 132 may use the masking module 204 to analyze the contents within the sample documents. For example, the masking module 204 may use a knowledge identification and fusion (KIF) detection model 404 to analyze the text contents within the sample document, and determine the information included within each of the text contents. Based on the locations and the information provided in the text contents, the KIF detection model 404 may determine the content type associated with each content location detected on the sample document. For example, the KIF detection model 404 may determine that the top of the image patch 424 of the sample document includes a document identification number, the middle of the image patch 424 includes a birthdate, and the bottom of the image patch 424 includes an expiration date.

The information extracted from the image patch 424 may be used by the AI module 132 to generate a prompt for a finetuned stable diffusion model 410. The finetuned stable diffusion model 410 may correspond to the AI model 210, or may be a separate AI model. In some embodiments, the AI module 132 may generate a prompt 430 that instructs the finetuned stable diffusion model 410 to remove the contents highlighted in the mask 428 and fill in the missing graphical background. In this regard, the AI module 132 may use one or more “EMPTY” tokens in the prompt 430 to accomplish the objective of removing the content and filling in the missing graphical background. For example, the prompt 430 may specify locations of the contents (e.g., coordinates of areas within the sample document, etc.) that need to be removed, and assign an “EMPTY” token at each of the locations. In this example, the prompt 430 includes “driver license USA Texas at [tx134, ty167], [EMPTY] at [10, 3, 430, 53], [EMPTY] at [11, 77, 467, 397], [EMPTY] at [11, 105, 467, 501]” where the words “[EMPTY]” represent the “EMPTY” tokens, and the four numbers inside each bracket pair represent the area (e.g., coordinates of four corners of a rectangle) of the content to be removed. Based on the prompt 430, the finetuned stable diffusion model 410 may remove the texts inside the locations specified in the prompt 430. As discussed herein, since the sample document typical includes background graphics for the purpose of fraud prevention, portions of the background graphics may be missing after removing the texts that cover the background graphics at those locations. As such, based on the “EMPTY” token, the finetuned stable diffusion model 410 may be trained to re-generate the missing background graphics around the areas that were originally covered by the texts. The finetuned stable diffusion model 410 may generate the modified image 432 with the texts removed and background graphics refilled.

The AI module 132 may then use a text generator 412 to generate replacement text and insert the replacement text at the locations of the document. The text generator 412 may correspond to the AI model 210 or may be a separate AI model. In some embodiments, the AI module 132 uses an optical character recognition (OCR) module 406 to recognize details, such as font type, font size, font shading, font resolution, and font variations, of each of the original contents in the image patch 424. The type of the data to be replaced (e.g., the document number, the birthdate, the expiration date, etc.), along with the font type and the font size information, may be provided to the text generator 412, such that the replacement texts (e.g., the replacement document number, the replacement birthdate, the replacement expiration date, etc.) may closely resemble the original texts in the image patch 424. After generating the replacement texts, the text generator 412 may insert the replacement texts in the specified location to generate the modified image patch 434. The image patch 434 may be attached to the original sample document to generate the modified document, which can be used to generate training data for the detection module 202.

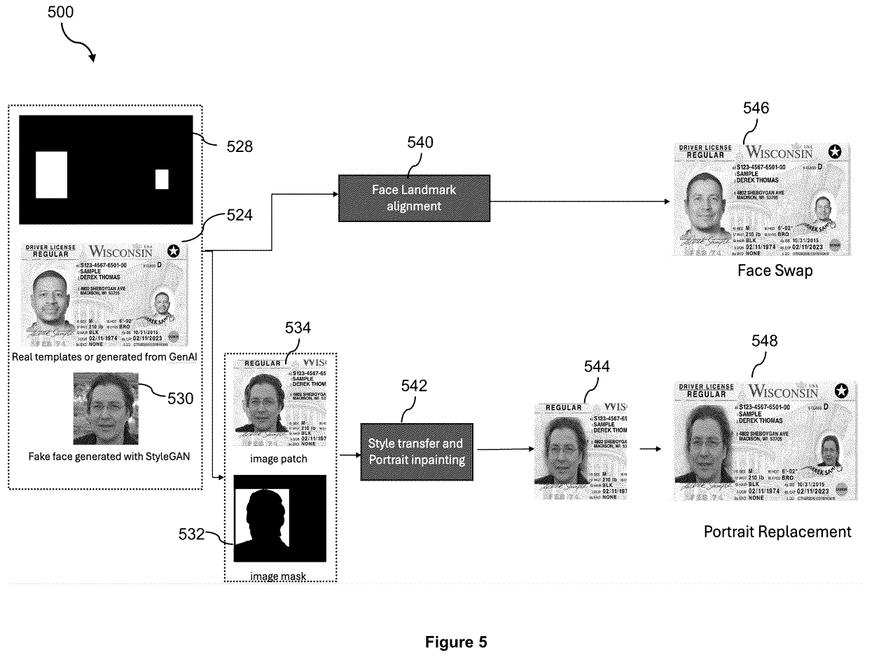

FIG. 5 illustrates an example data flow 500 for modifying image content in a sample document according to an embodiment of the disclosure. In addition to modifying text contents, the AI module 132 of some embodiments may also generate modified documents by modifying image content of a sample document. In this example, a sample document 524, which corresponds to a Wisconsin driver's license, is provided to the AI module 132. The sample document 524 includes two images of a person. In some embodiments, the AI module 132 may use the masking module 504 to generate a mask 528 for modifying the image content based on the sample document 524. The mask 528 may specify (e.g., highlight, etc.) the areas on the sample document 524 where the images of the person are located. The AI module 132 may then modify the two images of the person in the sample document 524 based on the sample document 524 and the mask 528.

In some embodiments, the AI module 132 may modify the images of the person appearing on the sample document 524 using two different techniques. For example, the AI module 132 may use a face-swap technique to modify only the face of the person on the two images. Using the face-swap technique, the AI module 132 may instruct the AI model 210 to artificially generate (e.g., synthetic) facial features (e.g., eyes, a nose, a mouth, etc.) of a person for replacing the face of the person in the original document 524. The AI module 132 may then instruct the AI model 210 to generate a modified document 546 based on replacing the face of the person in the sample document 524 using the newly generated facial features. The AI model 210 may generate the modified document 546 by removing the original facial features in the sample document 524 and inserting the newly generated facial features onto the images of the person in the sample document 524. In some embodiments, the AI module 132 may also use a face landmark alignment module 540 to correct the alignment of the facial features inserted onto the face of the person in the document 546. The modified document 546 may then be used by the AI module 132 to generate training data for training the detection module 202.

In another example, the AI module 132 may use a portrait replacement technique to modify the sample document 524. Unlike the face swap technique, the portrait replacement technique requires a complete replacement of the entire portrait of the person appearing on the sample document 524. As such, the AI module 132 may first instruct the AI model 210 to generate a new portrait 530. The AI module 132 may also use the masking module 204 to generate an image mask 532 for each of the images of the person in the sample document 524. The AI module 132 may instruct the AI model 210 to remove the portraits (e.g., the images of the person) from the sample document 524 using the image mask 532. In some embodiments, the AI module 132 may also instruct the AI model 210 to generate additional background graphics to fill the area of the sample document 524 where the portraits were removed, such that the document does not appear to have any missing background graphics. The AI model 210 may then be instructed to insert the new portrait 530 onto the portrait locations of the sample document 524 to generate the modified document 548. In some embodiments, the AI module 132 may also use a style transfer and portrait inpainting module 542 to modify the image 530 being inserted into the document 548, such that the image 530 looks consistent with the remaining portions of the document 548, e.g., similar resolution, contrast, and color. In some embodiments, the style transfer and portrait inpainting functions are being performed by the AI model 210. The modified document 548 may then be used by the AI module 132 to generate training data for training the detection module 202.

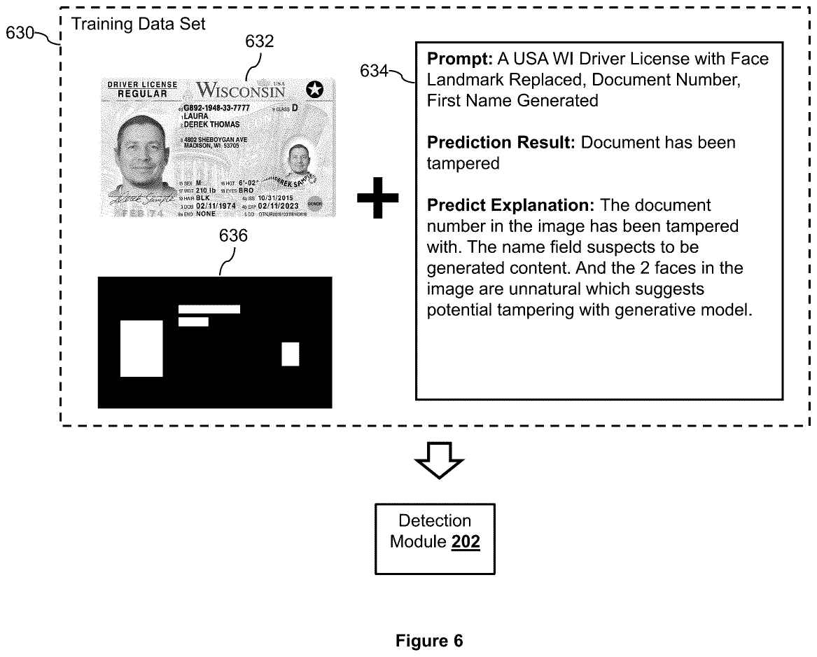

FIG. 6 illustrates an example training data set 630 according to an embodiment of the disclosure. In some embodiments, the training data set 630 may be generated by the AI module 132 for training the detection module 202. As shown, the training data set 630 includes a modified document 632 and annotations 634 generated for the modified document 632. The modified document 632 may be generated by the AI module 132 using one or more of the content modification techniques disclosed herein. In this example, the modified document 632 may be generated by modifying several contents, including the document number, the name, and the portraits, of a sample document. The annotations 634 may be generated by the AI module 132 to describe the modifications (e.g., the tampering) of the document. In this example, the annotations 634 provide that the modified document 632 is labeled as a tampered document. The annotations 634 further explains that the modified document 632 is a Wisconsin driver's license having the portraits, document number, and first name replaced, as well as why the modified document 632 is potentially tampered with. The training data set 630, along with other training data sets, may be provided to the training module 206 to train the detection module 202. For example, in each training iteration, the modified document (e.g., the modified document 632) of a training data set may be provided as input data to the detection module 202. The detection module 202 is configured to provide an output indicating whether the modified document 630 is a fraudulent document. Based on the deviation between the output of the detection module 202 and the labeled result included in the annotations 634, the training module 206 may provide feedback to the detection module 202 to adjust the parameters associated with the detection module 202 through a backward propagation process, which improves the prediction accuracy of the detection module 202 when performing subsequent prediction tasks.

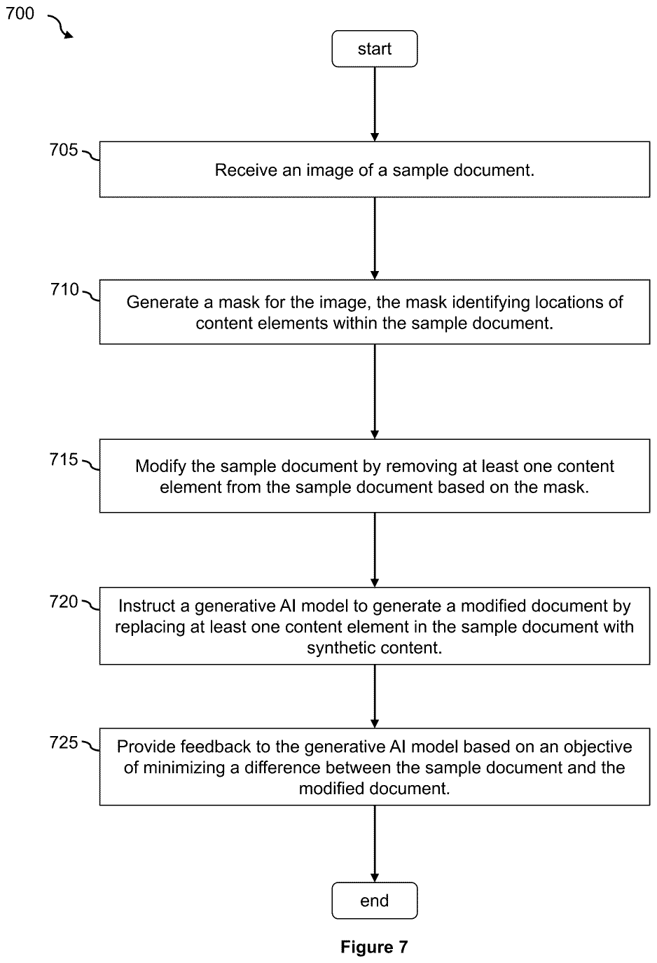

FIG. 7 illustrates a process 700 for training an artificial intelligence (AI) model to generate modified documents according to various embodiments of the disclosure. In some embodiments, at least a portion of the process 700 may be performed by the AI module 132, although one or more steps may be performed by one or more of the components/devices/modules/systems described herein. The process 700 begins by receiving (at step 705) an image of sample document. For example, the AI module 132 may obtain a government-issued sample document (e.g., the sample document 232) from a government website, from the user device 180, or generate a synthetic image of a document using the AI model 210.

The AI module 132 may then use the masking module 204 to generate (at step 710), based on the type of sample document, a mask for the image, the mask identifying locations of content elements within the sample document. For example, the mask may highlight the areas within the image (within the sample document) that correspond to the different contents (e.g., a document number, a name, a birthdate, etc.). The AI module 132 may instruct the AI model 210 to modify (at step 715) the sample document by removing at least one content element from the sample document based on the mask. For example, the AI module 132 may generate a prompt to include “EMPTY” tokens corresponding to specific areas within the sample document. Based on the prompt, the AI model 210 may remove the content(s) (e.g., text content, etc.) within the specified areas. In some embodiments, the AI model 210 may also generate additional background graphics to fill in the missing portions of the background graphics where the content(s) was removed based on the “EMPTY” token, such that the background graphics appear to be congruent.

The AI module 132 then instructs (at step 720) a generative AI model to generate a modified document by replacing at least one content element in the sample document with synthetic content. For example, the AI model 210 may first generate synthetic content(s) for the content(s) that was removed from the sample document (e.g., generating an arbitrary birthdate if the birthdate was removed, generating an arbitrary document number if the document number was removed, etc.). The AI model 210 then inserts the synthetic content(s) into the sample document at the locations where the original content(s) was removed.

After generating the modified document, the AI module 132 may provide (at step 725) feedback to the generative AI model based on an objective of minimizing a difference between sample documents of the same document type and the modified document. The AI module 132 may analyze the modified document. For example, the AI module 132 may compare the modified document against the original sample document (and other sample documents of the same document type). The comparison may not be based on the content of the documents (since some of the contents were modified), but based on the appearance (e.g., the look and feel, the font sizes and the font types of the texts, the background graphics, the spacing in the texts, how the portraits immersed with the remaining of the document, etc.). The AI module 132 may identify locations on the modified document where the similarity with the original sample document is below a threshold (e.g., a deviation is larger than a threshold, such as when there is missing background graphics, etc.). The feedback may be provided to the AI model 210 to adjust the parameters of the AI model 210 (e.g., through backward propagation, etc.). The AI module 132 may continue to instruct the AI model 210 to generate modified documents and provide feedback to the AI model 210 to continue to improve the performance of the AI model 210 in generating modified documents that mimic real-world fraudulent documents.

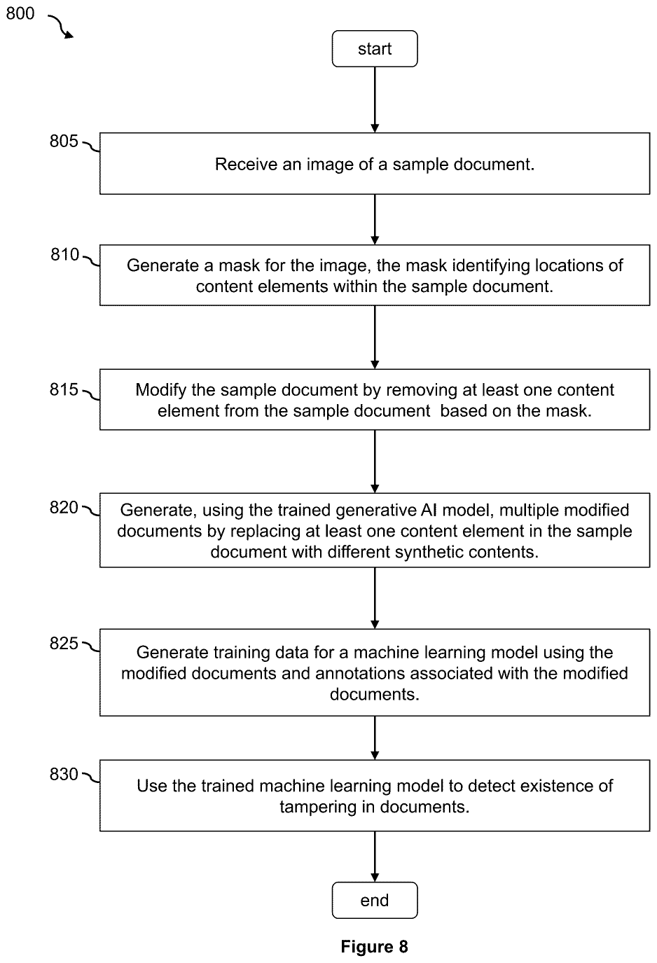

FIG. 8 illustrates a process 800 for generating training data for the training the machine learning model configured to classify documents according to various embodiments of the disclosure. In some embodiments, at least a portion of the process 800 may be performed by the AI module 132, although one or more steps may be performed by one or more of the components/devices/modules/systems described herein. The first four steps 805-820 of the process 800 are similar to the first four steps 705-720 of the process 700. For example, the process 800 begins by receiving (at step 805) an image of a sample document. The AI module 132 may then use the masking module 204 to generate (at step 810), based on the type of sample document, a mask for the image, the mask identifying locations of content elements within the sample document. The AI module 132 may instruct the trained AI model 210 to modify (at step 815) the sample document by removing at least one content element from the sample document based on the mask. The AI module 132 then instructs (at step 720) the trained AI model to generate a modified document by replacing at least one content element in the sample document with synthetic content.

After generating the modified document, the AI module 132 generates (at step 825) training data for a machine learning model using the modified documents and annotations associated with the modified documents. For example, the AI module 132 may use the AI model 210 to generate annotations for each of the modified documents. The annotations may include a label indicating that the modified document is a document that has been tampered with, locations and/or content types that have been modified, and descriptions of the appearance of each of the modified locations describing evidence of tampering.

The AI module 132 then uses (at step 825) the trained machine learning model to detect existence of tampering in documents. For example, AI module 132 may use the training module 206 to train the detection module 202 using the generated training data. After training the detection module 202, the AI module 132 may use the trained detection module to classify incoming documents submitted by various users (e.g., the user 140 of the user device 110, etc.). Since the document is typically submitted in association with a transaction request (e.g., an onboarding request, a request to access data, a request to process a transaction, etc.), the output of the detection module 202 may then be used by the service provider server 130 to process the transaction request (e.g., authorize, deny, or request additional information) for the user.

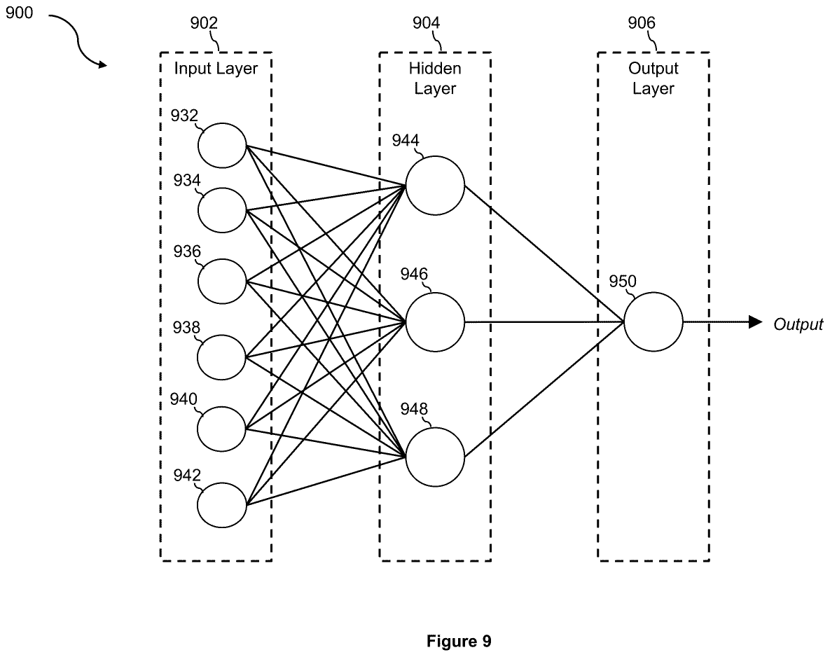

FIG. 9 illustrates an example artificial neural network 900 that may be used to implement a machine learning model, such as the AI model 210, the detection module 202, the generator 310, the finetuned stable diffusion model 410, and the text generator 412. As shown, the artificial neural network 900 includes three layers-an input layer 902, a hidden layer 904, and an output layer 906. Each of the layers 902, 904, and 906 may include one or more nodes (also referred to as “neurons”). For example, the input layer 902 includes nodes 932, 934, 936, 938, 940, and 942, the hidden layer 904 includes nodes 944, 946, and 948, and the output layer 906 includes a node 950. In this example, each node in a layer is connected to every node in an adjacent layer via edges and an adjustable weight is often associated with each edge. For example, the node 932 in the input layer 902 is connected to all of the nodes 944, 946, and 948 in the hidden layer 904. Similarly, the node 944 in the hidden layer is connected to all of the nodes 932, 934, 936, 938, 940, and 942 in the input layer 902 and the node 950 in the output layer 906. While each node in each layer in this example is fully connected to the nodes in the adjacent layer(s) for illustrative purpose only, it has been contemplated that the nodes in different layers can be connected according to any other neural network topologies as needed for the purpose of performing a corresponding task.

The hidden layer 904 is an intermediate layer between the input layer 902 and the output layer 906 of the artificial neural network 900. Although only one hidden layer is shown for the artificial neural network 900 for illustrative purpose only, it has been contemplated that the artificial neural network 900 used to implement any one of the computer-based models may include as many hidden layers as necessary. The hidden layer 904 is configured to extract and transform the input data received from the input layer 902 through a series of weighted computations and activation functions.

In this example, the artificial neural network 900 receives a set of inputs and produces an output. Each node in the input layer 902 may correspond to a distinct input. For example, when the artificial neural network 900 is used to implement the AI model 210, the nodes in the input layer 902 may correspond to different attributes of a sample document, a mask, and a prompt. When the artificial neural network 900 is used to implement the detection module 202, the nodes in the input layer 902 may correspond to different attributes of a document.

In some embodiments, each of the nodes 944, 946, and 948 in the hidden layer 904 generates a representation, which may include a mathematical computation (or algorithm) that produces a value based on the input values received from the nodes 932, 934, 936, 938, 940, and 942. The mathematical computation may include assigning different weights (e.g., node weights, edge weights, etc.) to each of the data values received from the nodes 932, 934, 936, 938, 940, and 942, performing a weighted sum of the inputs according to the weights assigned to each connection (e.g., each edge), and then applying an activation function associated with the respective node (or neuron) to the result. The nodes 944, 946, and 948 may include different algorithms (e.g., different activation functions) and/or different weights assigned to the data variables from the nodes 932, 934, 936, 938, 940, and 942 such that each of the nodes 944, 946, and 948 may produce a different value based on the same input values received from the nodes 932, 934, 936, 938, 940, and 942. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 902 is transformed into rather different values indicative data characteristics corresponding to a task that the artificial neural network 900 has been designed to perform.

In some embodiments, the weights that are initially assigned to the input values for each of the nodes 944, 946, and 948 may be randomly generated (e.g., using a computer randomizer). The values generated by the nodes 944, 946, and 948 may be used by the node 950 in the output layer 906 to produce an output value (e.g., a response to a user query, a prediction, etc.) for the artificial neural network 900. The number of nodes in the output layer depends on the nature of the task being addressed. For example, in a binary classification problem, the output layer may consist of a single node representing the probability of belonging to one class (as in the example shown in FIG. 9). In a multi-class classification problem, the output layer may have multiple nodes, each representing the probability of belonging to a specific class. When the artificial neural network 900 is used to implement the detection module 202, the output node 950 may be configured to generate a value that indicates whether the document is a fraudulent document. When the artificial neural network 900 is used to implement the AI model 210, the output node 950 may be configured to generate a modified document based on the sample document, the mask, and the prompt.

In some embodiments, the artificial neural network 900 may be implemented on one or more hardware processors, such as CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware used to implement the neural network structure is specifically configured based on factors such as the complexity of the neural network, the scale of the tasks (e.g., training time, input data scale, size of training dataset, etc.), and the desired performance.

The artificial neural network 900 may be trained by using training data based on one or more loss functions and one or more hyperparameters. By using the training data to iteratively train the artificial neural network 900 through a feedback mechanism (e.g., comparing an output from the artificial neural network 900 against an expected output, which is also known as the “ground-truth” or “label”), the parameters (e.g., the weights, bias parameters, coefficients in the activation functions, etc.) of the artificial neural network 900 may be adjusted to achieve an objective according to the one or more loss functions and based on the one or more hyperparameters such that an optimal output is produced in the output layer 906 to minimize the loss in the loss functions. Given the loss, the negative gradient of the loss function is computed with respect to each weight of each layer individually. Such negative gradient is computed one layer at a time, iteratively backward from the last layer (e.g., the output layer 906 to the input layer 902 of the artificial neural network 900). These gradients quantify the sensitivity of the network's output to changes in the parameters. The chain rule of calculus is applied to efficiently calculate these gradients by propagating the gradients backward from the output layer 906 to the input layer 902.

Parameters of the artificial neural network 900 are updated backwardly from the last layer to the input layer (backpropagating) based on the computed negative gradient using an optimization algorithm to minimize the loss. The backpropagation from the last layer (e.g., the output layer 906) to the input layer 902 may be conducted for a number of training samples in a number of iterative training epochs. In this way, parameters of the artificial neural network 900 may be gradually updated in a direction to result in a lesser or minimized loss, indicating the artificial neural network 900 has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as to predict a frequency of future related transactions.

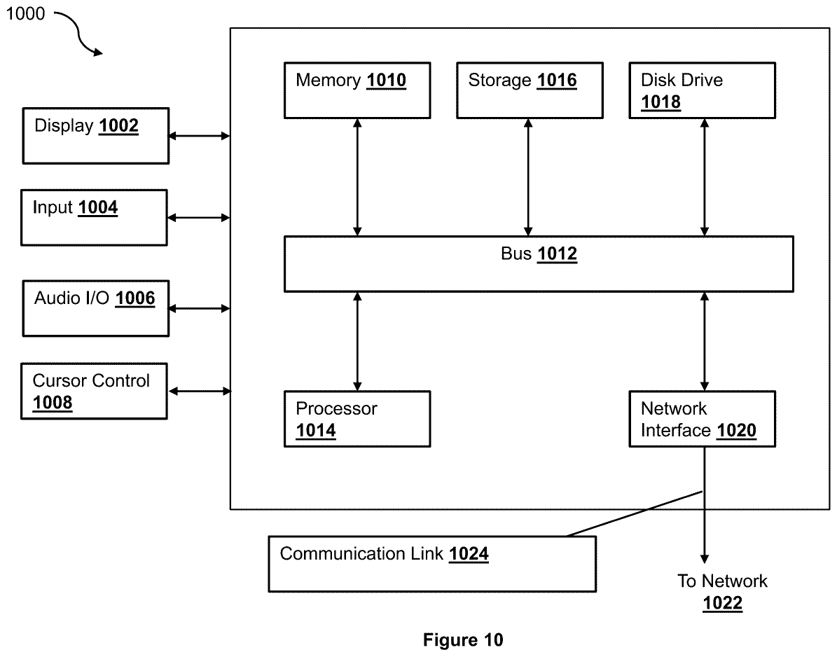

FIG. 10 is a block diagram of a computer system 1000 suitable for implementing one or more embodiments of the present disclosure, including the service provider server 130, the merchant server 120, the user device 180, and the user device 110. In various implementations, each of the user devices 110 and 180 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices 110, 120, 130, and 180 may be implemented as the computer system 1000 in a manner as follows.

The computer system 1000 includes a bus 1012 or other communication mechanism for communicating information data, signals, and information between various components of the computer system 1000. The components include an input/output (I/O) component 1004 that processes a user (i.e., sender, recipient, service provider) action, such as selecting keys from a keypad/keyboard, selecting one or more buttons or links, etc., and sends a corresponding signal to the bus 1012. The I/O component 1004 may also include an output component, such as a display 1002 and a cursor control 1008 (such as a keyboard, keypad, mouse, etc.). The display 1002 may be configured to present a login page for logging into a user account or a checkout page for purchasing an item from a merchant. An optional audio input/output component 1006 may also be included to allow a user to use voice for inputting information by converting audio signals. The audio I/O component 1006 may allow the user to hear audio. A transceiver or network interface 1020 transmits and receives signals between the computer system 1000 and other devices, such as another user device, a merchant server, or a service provider server via a network 1022. In one embodiment, the transmission is wireless, although other transmission mediums and methods may also be suitable. A processor 1014, which can be a micro-controller, digital signal processor (DSP), or other processing component, processes these various signals, such as for display on the computer system 1000 or transmission to other devices via a communication link 1024. The processor 1014 may also control transmission of information, such as cookies or IP addresses, to other devices.

The components of the computer system 1000 also include a system memory component 1010 (e.g., RAM), a static storage component 1016 (e.g., ROM), and/or a disk drive 1018 (e.g., a solid-state drive, a hard drive). The computer system 1000 performs specific operations by the processor 1014 and other components by executing one or more sequences of instructions contained in the system memory component 1010. For example, the processor 1014 can perform the fraudulent documents generation functionalities described herein, for example, according to the processes 700 and 800.

Logic may be encoded in a computer readable medium, which may refer to any medium that participates in providing instructions to the processor 1014 for execution. Such a medium may take many forms, including but not limited to, non-volatile media, volatile media, and transmission media. In various implementations, non-volatile media includes optical or magnetic disks, volatile media includes dynamic memory, such as the system memory component 1010, and transmission media includes coaxial cables, copper wire, and fiber optics, including wires that comprise the bus 1012. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 1000. In various other embodiments of the present disclosure, a plurality of computer systems 1000 coupled by the communication link 1024 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system comprising:
a non-transitory memory; and
one or more hardware processors coupled with the non-transitory memory and configured to execute instructions from the non-transitory memory to cause the system to:
obtain an image of a sample document;
generate, based on analyzing a plurality of elements within the image, a mask that identifies a plurality of locations on the image that corresponds to the plurality of elements, wherein each element in the plurality of elements comprises a corresponding content;
modify the image using a generative artificial intelligence (AI) model and based on the mask, wherein modifying the image comprises removing a first content associated with a first element in the plurality of elements from the image; and
generate, using the generative AI model, a first synthetic document based on the modified image, wherein generating the first synthetic document comprises inserting a first synthetic content into a first location within the modified image corresponding to the first element.

2. The system of claim 1, wherein executing the instructions further causes the system to:
generate training data based on the first synthetic document, wherein generating the training data comprises labeling the first location within the first synthetic document as tampered content; and
train a machine learning model configured to detect tampering of documents using the training data.

3. The system of claim 1, wherein the modifying the image further comprises removing a second content associated with a second element in the plurality of elements from the image, and wherein executing the instructions further causes the system to:
generate, using the generative AI model, a second synthetic document based on the modified image, wherein generating the second synthetic document comprises inserting a second synthetic content into a second location within the modified image corresponding to the second element.

4. The system of claim 1, wherein the first content comprises at least one of a text content or an image content.

5. The system of claim 1, wherein the first content comprises a first image content associated with a face of a person, and wherein executing the instructions further causes the system to:
generate, using the generative AI model, the first synthetic content comprising second image content associated with a synthetic face.

6. The system of claim 1, wherein the first synthetic content is generated based on second content associated with a second element in the plurality of elements from the image.

7. The system of claim 1, wherein modifying the image comprises generating, using the generative AI model, additional background image data for one or more portions of the image corresponding to the first element.

8. A method, comprising:
obtaining, by a computer system, an image of a sample document;
generating, by the computer system and based on analyzing a plurality of elements within the sample document, a mask that specifies a plurality of areas within the sample document that corresponds to the plurality of elements, wherein each element in the plurality of elements comprises a corresponding content; and
generating, by the computer system and using a generative artificial intelligence (AI) model, a first modified document based on the sample document and the mask, wherein the generating the first modified document comprises instructing the generative AI model to (i) remove a first content associated with a first element in the plurality of elements from the sample document based on the mask and (ii) insert a first synthetic content into a first area within the sample document corresponding to the first element.

9. The method of claim 8, wherein the generating the first modified document comprises providing, to the generative AI model, a prompt that includes a token that maps to the first area.

10. The method of claim 9, wherein the generative AI model is trained to remove the first content from the first area and fill one or more missing portions of a graphical background of the sample document in the first area based on the token.

11. The method of claim 8, wherein the generative AI model is trained to generate the first modified document with an objective to reduce a difference between the first modified document and the sample document.

12. The method of claim 8, further comprising:
generating training data based on the first modified document, wherein the generating the training data comprises labeling the first area within the first modified document as tampered content; and
training a machine learning model configured to detect tampering of documents using the training data.

13. The method of claim 8, further comprising:
generating, using the generative artificial intelligence (AI) model, a second modified document based on the sample document and the mask, wherein the generating the second modified document comprises instructing the generative AI model to (i) remove a second content associated with a second element in the plurality of elements from the sample document based on the mask and (ii) insert a second synthetic content into a second area within the sample document corresponding to the second element.

14. The method of claim 8, wherein the first content comprises a first image content associated with a face of a person, and wherein the method further comprises:
generating, using the generative AI model, the first synthetic content comprising a second image content associated with a synthetic face.

15. A non-transitory machine-readable medium having stored thereon machine-readable instructions executable to cause a machine to perform operations comprising:
accessing an image of a sample document;
generating, based on analyzing the sample document, a mask, based on a type of the sample document, that specifies a plurality of areas within the sample document that corresponds to the plurality of contents; and
generating, using a generative artificial intelligence (AI) model, a first modified document based on the sample document and the mask, wherein the generating the first modified document comprises instructing the generative AI model to (i) remove a first content of the plurality of contents from the sample document based on the mask and (ii) insert a first synthetic content into a first area of the plurality of areas within the sample document corresponding to the first content.

16. The non-transitory machine-readable medium of claim 15, wherein the generating the first modified document comprises providing, to the generative AI model, a prompt that includes an “EMPTY” token that maps to the first area.

17. The non-transitory machine-readable medium of claim 16, wherein the generative AI model is trained to remove the first content from the first area and fill one or more missing portions of a graphical background of the sample document in the first area based on the “EMPTY” token.

18. The non-transitory machine-readable medium of claim 15, wherein the generative AI model is trained to generate the first modified document with an objective to reduce a difference between the first modified document and the sample document.

19. The non-transitory machine-readable medium of claim 15, wherein the operations further comprise:
generating training data based on the first modified document, wherein the generating the training data comprises labeling the first modified document as tampered content; and
training a machine learning model configured to detect tampering of documents using the training data.

20. The non-transitory machine-readable medium of claim 19, wherein the operations further comprise:
generating, using the generative artificial intelligence (AI) model and for the first modified document, annotations describing a location of the first element that has been modified and a manner in which the first content was modified, wherein the training data comprises the first modified document and the annotations.
